(19) United States
(12) Patent Application Publication
(10) Pub. No.: US 2013/0117667 A1
(43) Pub. Date: May 9, 2013

(54) SYSTEM AND METHOD FOR IN CONTENT DISCUSSIONS

(71) Applicant: barnesandnoble.com llc, New York, NY (US)

(72) Inventor: Matthew PALLAKOFF, Mountain View, CA (US)

(73) Assignee: barnesandnoble.com llc, New York, NY (US)

(21) Appl. No.: 13/670,690

(22) Filed: Nov. 7, 2012

Related U.S. Application Data
(60) Provisional application No. 61/557,760, filed on Nov. 9, 2011.

(51) Int. Cl. G06F 17/30

(52) U.S. Cl. CPC G06F 17/30011
USPC 715/273

(57) ABSTRACT

Systems and methods for permitting in-content discussions regarding electronic content are described. The present invention allow users of digital publication readers to share comments regarding specific parts of an electronic publication with other users that are concurrently reading or have previously read those parts. In this manner, the invention provides users the ability to share their feelings or thoughts about electronic publications and, in so doing, significantly enhance their knowledge and reading experience.

### FIELD OF THE INVENTION

The present invention relates generally to digital publications, and more particularly to systems that allow social interaction between users of digital publication readers.

### BACKGROUND OF THE INVENTION

Electronic devices that permit users to read electronic publications are known. These devices are typically stand alone devices that permit users only to read publications in private, without the benefit of feedback and/or comments from other users who may be reading the same publications. There is a need for such devices to allow for a more interactive experience among groups of readers of the same electronic publications so that feedback and comments may be shared.

### SUMMARY OF THE INVENTION

The present invention operates in connection with a reader for digital publication, such as electronic books or eBooks. The present invention allows readers of digital publications to start or enter an online discussion with other readers about specific portions of the digital publications.

### BRIEF DESCRIPTION OF THE DRAWINGS

For the purposes of illustrating the present invention, there is shown in the drawings a form which is presently preferred, it being understood however, that the invention is not limited to the precise form shown by the drawing in which:

FIG. 1 illustrates an exemplary system according to the present invention;

FIGS. 2 and 3 illustrate a first embodiment of the present invention allowing a user to see and join a discussion about a digital publication.

FIGS. 4 and 5 illustrate an alternative embodiment of the present invention allowing a user to see and join a discussion about a digital publication;

FIG. 6 illustrates an alternative embodiment of a discussion panel; and

FIG. 7 illustrates the components of an exemplary device.

### DETAILED DESCRIPTION OF THE INVENTION

The advent of the electronic reader, which allows user to read books, periodicals, or whatever other material that previously had been available only through printed medium, opens new worlds of opportunity for social interaction regarding the written word. Embodiments of the present invention allow users of digital publication readers to discuss specific parts of an electronic publication with other users that are concurrently reading or have previously read those parts. In this manner, the present invention provides users the ability to share their feelings or thoughts about electronic publications and, in so doing, significantly enhance their knowledge and reading experience.

As appreciated by those skilled in the art, the specific algorithm for defining “a specific part” of the electronic publication can vary by design. In some embodiments, the specific part could be a passage that the user is reading, a specific page, the current chapter, a recipe in a cook book, an article in a magazine, or anything within an area of the publication that the user may be viewing. Although some descriptions contained herein use the term “page” to represent the current spot in the electronic publication where the discussions are taking place, the “page” being viewed by a particular user may or may not correspond to a specific page number being viewed by other users. The present invention recognizes that, with respect to electronic publications, “page number” is a fluid concept because different readers, and combinations of different software and hardware, use different font sizes and screen sizes leading to different pagination of the same electronic publication.

In one embodiment of the present invention, the in-content discussions described herein are linked to a less malleable element of the book, a specific paragraph or sentence, or the start or end of a chapter. Reference might still be made to the spot as “page,” but if one user is at the end of chapter 5 on page 200 in his/her electronic publication, and another user reading the same publication is at the end of chapter 5 on page 100, both users see the same in-content discussions for that part of the digital publication. In one embodiment, the user's device 130 can determine what is the last character displayed on the screen for the page which the user is currently viewing. If this character is defined as character position “X,” the user will be presented with in-content discussions that relate to or include position “X” in the publication.

In an another embodiment of the present invention, users are provided with varying levels of control, so that a user's reading behavior or other personal information is not made public without permission.

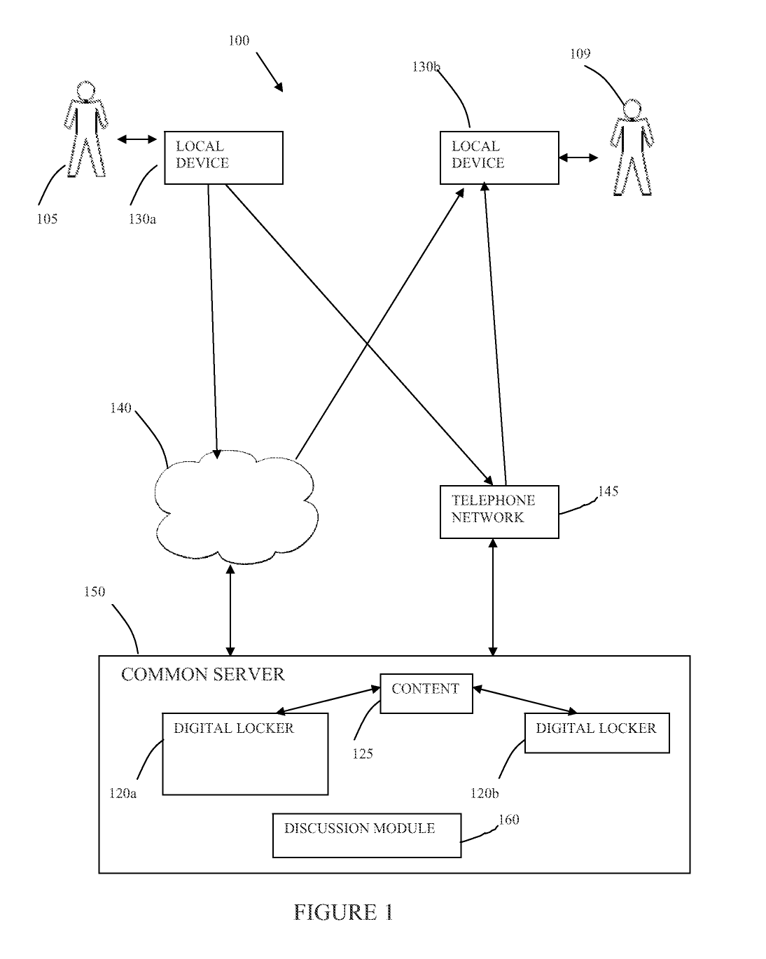

Referring now to FIG. 1 there is seen components of a discussion system according to the present invention. User 105 is an authorized user of system 100 and uses her local device 130a for the reading of digital content and interacting with other users 109. Many of the functions of system 100 of the present invention are carried out on server 150. As appreciated by those skilled in the art, many of the functions described herein can be divided between the server 150 and the user's local device 130a. Further, as also appreciated by those skilled in the art, server 150 can be considered a “cloud” with respect to the user and her local device 130a. The cloud can actually be comprised of several servers performing interconnected and distributed functions. For the sake of simplicity, only a single server 150 will be described. The user 105 can connect to the server 150 via the Internet 140, a telephone network 145 (e.g., wirelessly through a cellphone network) or other suitable electronic communication means. User 105 has an account on server 150, which authorizes user 105 to use system 100.

Associated with the user's 105 account is the user's 105 digital locker 120a located on the server 150. As further described below, in the preferred embodiment of the present invention, digital locker 120a contains links to copies of digital content 125 previously purchased (or otherwise legally acquired) by user 105.

Indicia of rights to all copies of digital content 125 owned by user 105, including digital content 125, is stored by reference in digital locker 120a. Digital locker 120a is a remote online repository that is uniquely associated with the user's 105 account. As appreciated by those skilled in the art, the actual copies of the digital content 125 need not be necessarily stored in the user's locker 120a, but rather the locker 120a may store an indication of the rights of the user to the particular content 125 and a link or other reference to the actual digital content 125. Typically, the actual copy of the digital content 125 is stored in another mass storage device (not shown). The digital lockers 120 of all of the users 105, 109 who have purchased a copy of a particular digital content 125 would point to this copy in mass storage. Of course, back up copies of all digital content 125 are maintained for disaster recovery purposes. Although only one example of digital content 125 is illustrated in FIG. 1, the server 150 may contain millions of files 125 containing digital content. It is also contemplated that the server 150 may be comprised of several servers with access to a plurality of storage devices containing digital content 125. As further appreciated by those skilled in the art, in conventional licensing programs, the user does not own the actual copy of the digital content, but has a license to use it. Hereinafter, if reference is made to “owning” the digital content, it is understood what is meant is the license or right to use the content.

Also contained in the user's digital locker 120a is her contacts list. In a preferred embodiment, the user's contact list will also indicate if a contact is also an authorized (registered) user of the system 100 with his or her own account on server 150. This information can be use by discussion module 160 to display to a user 105, her “friends,” contacts that are currently reading a specific piece of material as described herein.

User 105 can access his or her digital locker 120a using a local device 130a. Local device 130a is an electronic device such as a personal computer, an e-book reader, a smart phone or other electronic device that the user 105 can use to access the server 150. In a preferred embodiment, the local device has been previously associated and registered with the user's 105 account using user's 105 account credentials. Local device 130a provides the capability for user 105 to download user's 105 copy of digital content 125 via his or her digital locker 120a. After digital content 125 is downloaded to local device 130a, user 105 can engage with the downloaded content locally, e.g., read a book, listen to music or watch a video.

In a preferred embodiment, local device 130a includes a non-browser based device interface that allows user 105 to initiate the discussion functionality of system 100 in a non-browser environment. Through the device interface, the user 105 is automatically connected to the server 150 in a non-browser based environment. This connection to the server 150 is a secure interface and can be through the telephone network 145, typically a cellular network for mobile devices. If user 105 is accessing his or her digital locker 120a using the Internet 140, local device 130a also includes a web account interface. Web account interface provides user 105 with browser-based access to his or her account and digital locker 120a over the Internet 140.

User 109 is also an authorized user of system 100. As with user 105, user 109 has an account with server 150, which authorizes user 109 to use system 100. As appreciated by those skilled in the art, the number of users 105, 109 that employ the present invention at the same time is only limited by the scalability of server 150. As with user 105, user 109 can access his or her digital locker 120b using her local device 130b. In a preferred embodiment, local device 130b is a device that user 109 has previously associated and registered with his or her account using user's 109 account credentials. Local device 130b allows user 109 to download copies of his digital content 125 from digital locker 120b. User 109 can engage with downloaded digital content 125 locally on local device 130b.

Discussion Module 160 of server 150 tracks discussions associated with specific parts of each electronic publication and, optionally, discussions associated with the publication in general. Discussion Module 160 records text that users submit to a discussion, the dates that text was submitted and, optionally, the times of the contributions, the IDs or handles of the users contributing each submission (with the user's permission), and other data commonly associated with discussion threads or, optionally, real time chats.

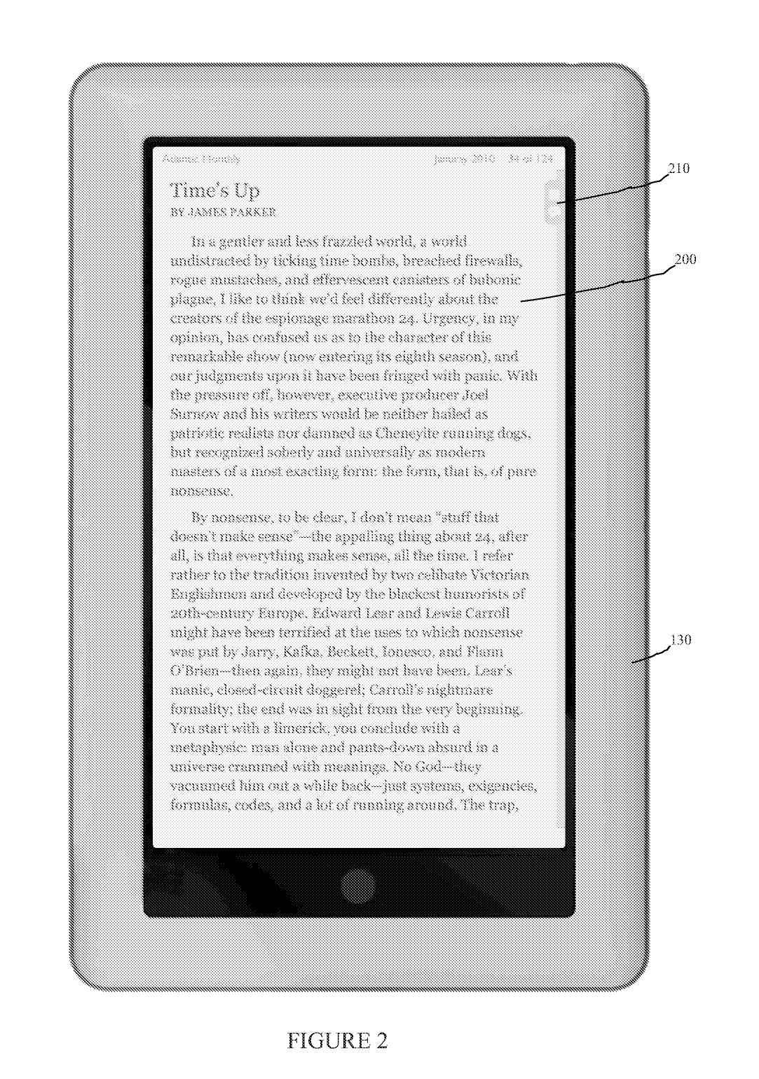

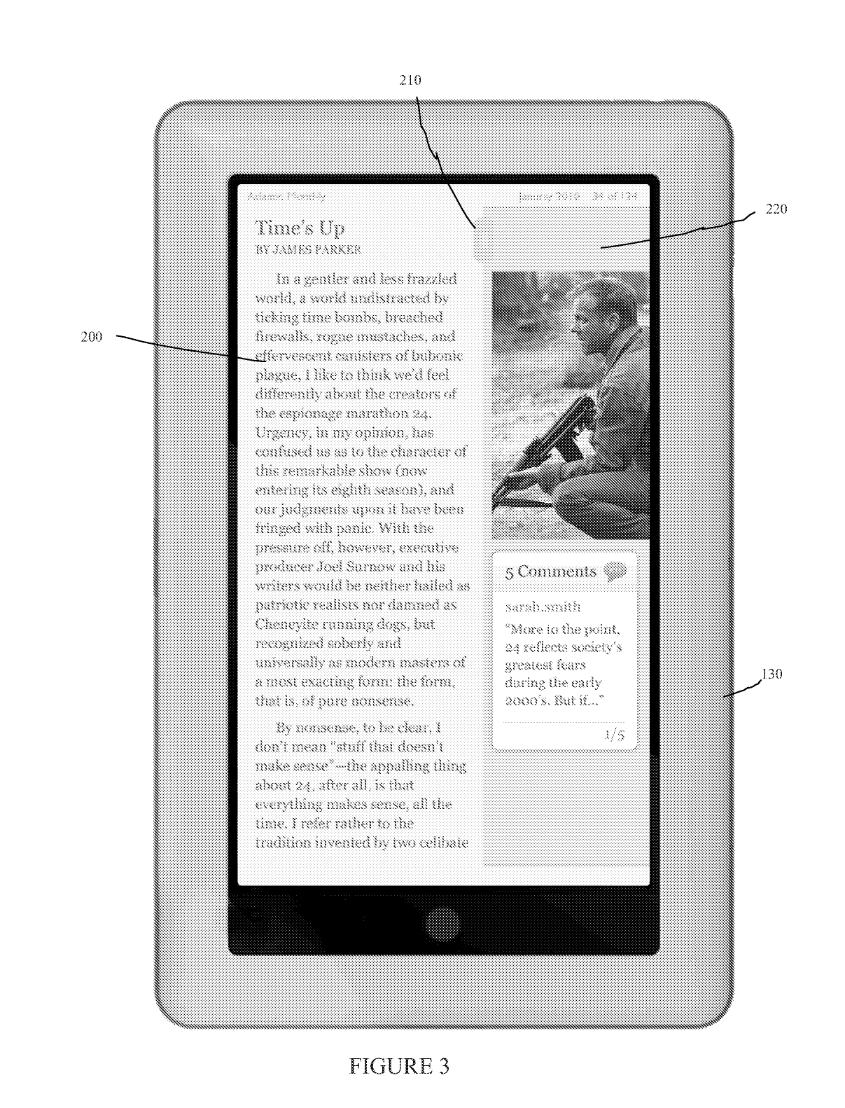

In an operational example, a user has just finished reading a moving or shocking passage in a novel, or the user is on a particular recipe page in a cookbook and has some thoughts or questions. FIGS. 2 and 3 illustrate a first embodiment of the present invention. As illustrated in these Figures, a user is reading an article 200 from a digital periodical in her electronic reading device 130. In addition to the content of the article 200, the user interface displayed on the screen of device 130 contains a control 210 (see FIG. 2). By activating control 210, as depicted in FIG. 3, the user reveals a discussion panel 220 associated with that spot in the content 200. FIG. 3 shows people commenting on the content of the article 200. In the embodiment illustrated in FIGS. 2 and 3, the control 210 is in the form of a tab that can be pulled, on a touch screen, to reveal the discussion panel 220. In the embodiment illustrated in FIG. 3, only one comment 230 by one user is displayed in the discussion panel 220. In other embodiments, as discussed below, multiple comments from multiple users can be displayed in discussion panel 220 as a scrollable list.

Control 210 can be toggled between visible and hidden, with other tool icons. Another alternative is to use a special gesture such as a two finger tap in the middle of the page of the digital publication to activate the discussion panel 220.

In other embodiments, a user taps a comment to open a larger discussion panel or expose fields for adding or replying to comments. In yet other embodiments, the “Comment” or “Reply” buttons are provided.

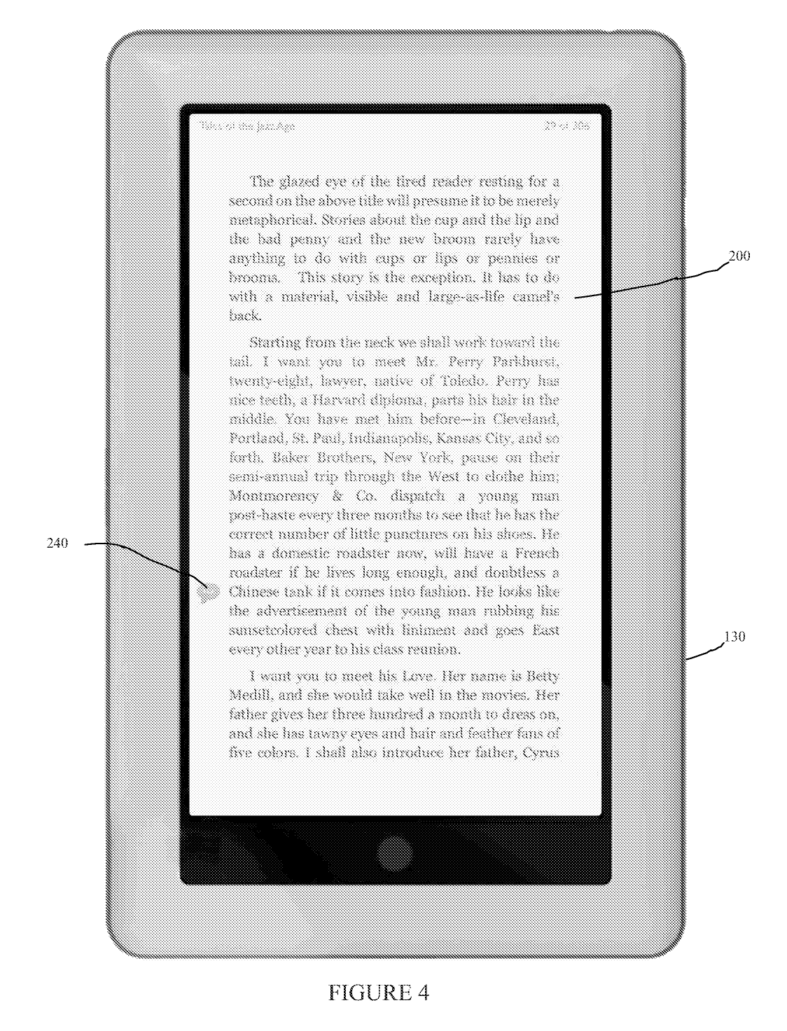

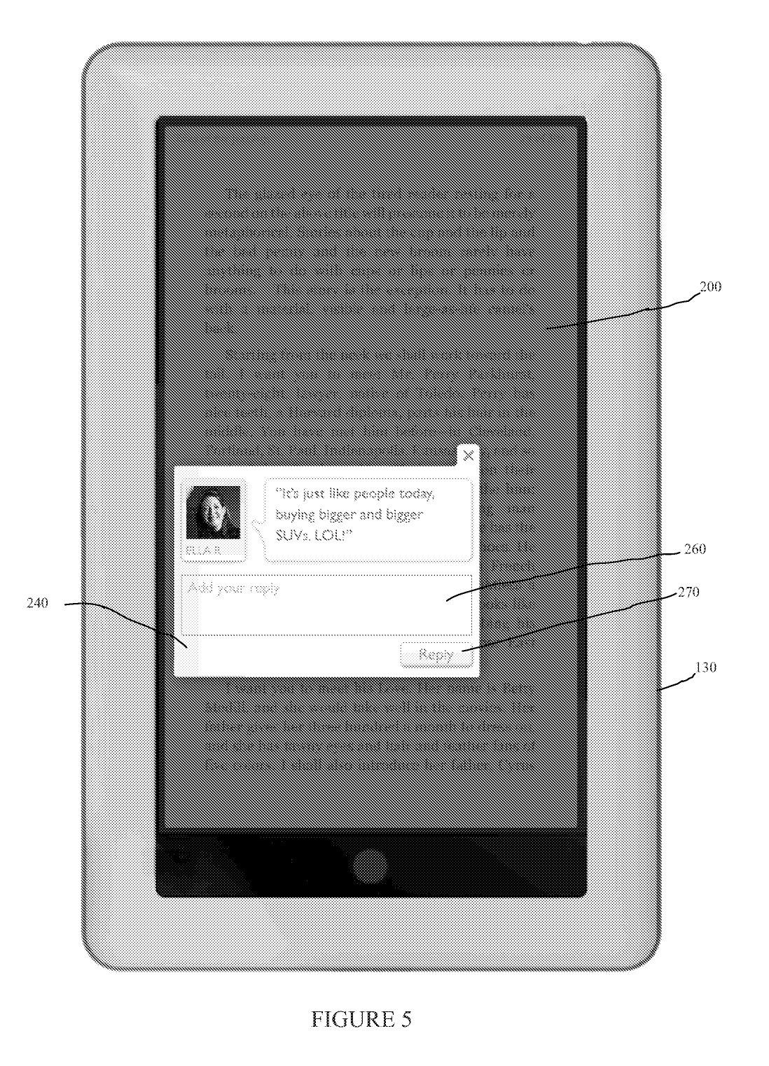

FIGS. 4 and 5 illustrate an alternative embodiment of the present invention. As with the embodiment illustrated in FIG. 2, the user is reading the content 200 of a digital publication on her electronic reader 130. In contrast to the embodiment of FIGS. 2 and 3, a control icon, bubble 240, appears if there is a discussion associated with the text of content 200 currently displayed on the user's device 130. As illustrated in FIG. 5, a user can tap on the bubble 240 to see the discussion. In the embodiment illustrated in FIG. 5, a pop-up window 250 is displayed showing the latest comment made by a user regarding the passage. The pop-up window 250 shows the comment from the other user, as well as providing an area 260 for the user to type a comment and join the discussion. Once the user has finished typing comments, tapping the Reply button 270 posts the comment.

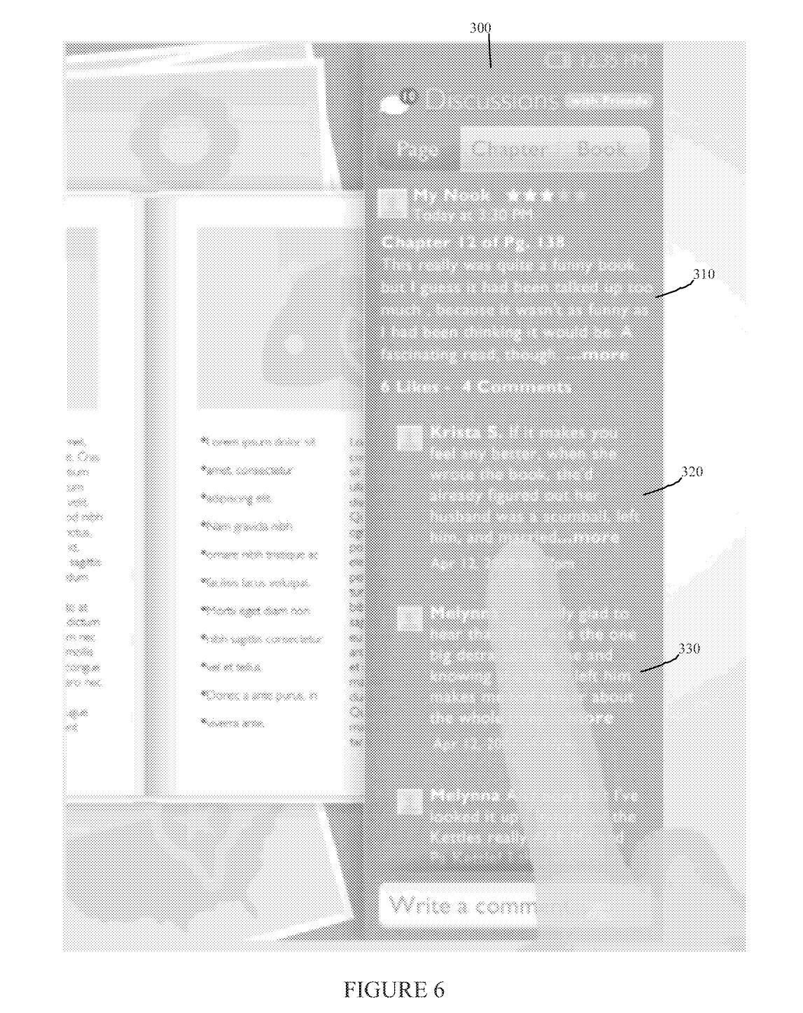

FIG. 6 illustrates an alternative embodiment of a discussion panel. The user can look at the discussion associated with this spot in the book, e.g., this recipe in a cook book, or he can tap a tab or button to view discussions associated with this chapter, e.g., the “Desert” chapter of a cook book, or a tab or button to view discussions associated with the book in general. In the discussion panel 300 illustrated in FIG. 6, a user has started a discussion by making a comment 310. Other users have subsequently made additional comments 320, 330 to add to the discussion. The comments of each of the users are identified by the user's user ID, the time/date of the posting and other personal information the user wishes to share, e.g., age, location.

As shown in FIG. 6, the user has the option to join in discussions regarding multiple levels of the digital content. For example, for an electronic publication, the user can join discussion about the page, the chapter or the publication in general. Further, for each section there may be multiple “threads” of discussions, discussing different aspects of the digital publication, e.g., a discussion about the author or a discussion about the use of imagery in a publication.

As appreciated by those skilled in the art, all of the users who add comments to a discussion are connected to a common sever, network or servers or network, e.g., server 150, as described above, which allows other users to view and add to discussion threads. The discussions are all stored on the server 150 as illustrated in FIG. 1 and are associated with the particular digital publication 125. More specifically, the comments/discussions are all tagged/linked to a specific portion of the digital content 125 on which the users are commenting. When a user owns a copy of a particular item of digital content 125, and she logs onto the server 150, the user's copy of the digital content 125 on her local device 130a can be updated to include the comments of others that were stored on the server 150 in association with the item 125 of digital content. If the user 105 remains connected to the server 150, she can receive near real time updates of comments by others in a chat room/discussion type session.

Embodiments of the present invention allow users to filter comments associated with a discussion. For example, in one embodiment, users can limit the visibility of their comments to just their contacts or their “friends.” Alternatively, the user can make her comments visible to the entire world of users. Further, the user is able to filter whose comments are displayed on his/her reading device. For example, the user can toggle between “I want to see everyone's comments” and “I just want to see comments from my friends.”

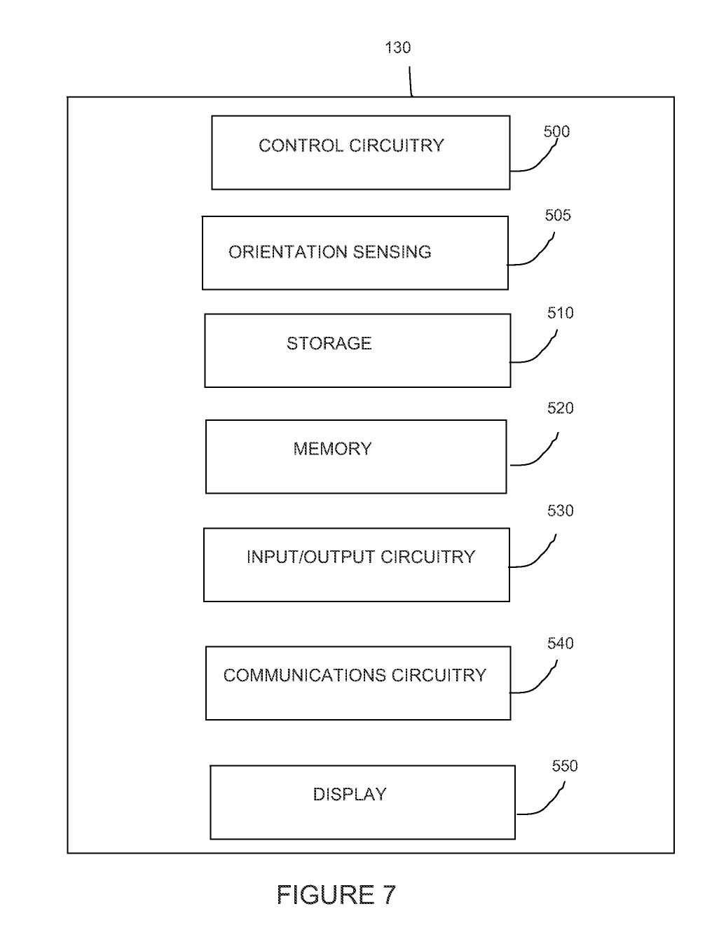

FIG. 7 illustrates an exemplary local device 130. As appreciated by those skilled the art, the local device 130 can take many forms capable of operating the present invention. As previously described, in a preferred embodiment the local device 130 is a mobile electronic device, and in an even more preferred embodiment device 130 is an electronic reader device. Electronic device 130 can include control circuitry 500, storage 510, memory 520, input/output (I/O) circuitry 530, communications circuitry 540, and display 550. In some embodiments, one or more of the components of electronic device 130 can be combined or omitted, e.g., storage 510 and memory 520 may be combined. As appreciated by those skilled in the art, electronic device 130 can include other components not combined or included in those shown in this Figure, e.g., a power supply such as a battery, an input mechanism, etc.

Electronic device 130 can include any suitable type of electronic device. For example, electronic device 130 can include a portable electronic device that the user may hold in his or her hand, such as a digital media player, a personal e-mail device, a personal data assistant (“PDA”), a cellular telephone, a handheld gaming device, a tablet device or an eBook reader. As another example, electronic device 130 can include a larger portable electronic device, such as a laptop computer. As yet another example, electronic device 130 can include a substantially fixed electronic device, such as a desktop computer.

Control circuitry 500 can include any processing circuitry or processor operative to control the operations and performance of electronic device 130. For example, control circuitry 500 can be used to run operating system applications, firmware applications, media playback applications, media editing applications, or any other application. Control circuitry 500 can drive the display 550 and process inputs received from a user interface, e.g., the display 550 if it is a touch screen.

Orientation sensing component 505 includes orientation hardware such as, but not limited to, an accelerometer or a gyroscopic device and the software operable to communicate the sensed orientation to the control circuitry 500. The orientation sensing component 505 is coupled to control circuitry 500 that controls the various input and output to and from the other various components. The orientation sensing component 505 is configured to sense the current orientation of the portable mobile device 130 as a whole. The orientation data is then fed to the control circuitry 500 which control an orientation sensing application. The orientation sensing application controls the graphical user interface (GUI), which drives the display 550 to present the GUI for the desired mode.

Storage 530 can include, for example, one or more computer readable storage mediums including a hard-drive, solid state drive, flash memory, permanent memory such as ROM, magnetic, optical, semiconductor, paper, or any other suitable type of storage component, or any combination thereof. Storage 510 can store, for example, media content, e.g., eBooks, music and video files, application data, e.g., software for implementing functions on electronic device 130, firmware, user preference information data, e.g., content preferences, authentication information, e.g., libraries of data associated with authorized users, transaction information data, e.g., information such as credit card information, wireless connection information data, e.g., information that can enable electronic device 130 to establish a wireless connection, subscription information data, e.g., information that keeps track of podcasts or television shows or other media a user subscribes to, contact information data, e.g., telephone numbers and email addresses, calendar information data, and any other suitable data or any combination thereof. The instructions for implementing the functions of the present invention may, as non-limiting examples, comprise software and/or scripts stored in the computer-readable media 530.

Memory 520 can include cache memory, semi-permanent memory such as RAM, and/or one or more different types of memory used for temporarily storing data. In some embodiments, memory 520 can also be used for storing data used to operate electronic device applications, or any other type of data that can be stored in storage 510. In some embodiments, memory 520 and storage 510 can be combined as a single storage medium.

I/O circuitry 530 can be operative to convert, and encode/decode, if necessary analog signals and other signals into digital data. In some embodiments, I/O circuitry 530 can also convert digital data into any other type of signal, and vice-versa. For example, I/O circuitry 530 can receive and convert physical contact inputs, e.g., from a multi-touch screen. i.e., display 550, physical movements, e.g., from a mouse or sensor, analog audio signals, e.g., from a microphone, or any other input. The digital data can be provided to and received from control circuitry 500, storage 510, and memory 520, or any other component of electronic device 130. Although I/O circuitry 530 is illustrated in this Figure as a single component of electronic device 130, several instances of I/O circuitry 530 can be included in electronic device 130.

Electronic device 130 can include any suitable interface or component for allowing a user to provide inputs to I/O circuitry 530. For example, electronic device 130 can include any suitable input mechanism, such as a button, keypad, dial, a click wheel, or a touch screen, e.g., display 550. In some embodiments, electronic device 130 can include a capacitive sensing mechanism, or a multi-touch capacitive sensing mechanism.

In some embodiments, electronic device 130 can include specialized output circuitry associated with output devices such as, for example, one or more audio outputs. The audio output can include one or more speakers, e.g., mono or stereo speakers, built into electronic device 130, or an audio component that is remotely coupled to electronic device 130, e.g., a headset, headphones or earhuds that can be coupled to device 130 with a wire or wirelessly.

Display 550 includes the display and display circuitry for providing a display visible to the user. For example, the display circuitry can include a screen, e.g., an LCD screen that is incorporated in electronics device 130. In some embodiments, the display circuitry can include a coder/decoder (Codec) to convert digital media data into analog signals. For example, the display circuitry or other appropriate circuitry within electronic device 1 can include video Codecs, audio Codecs, or any other suitable type of Codec.

The display circuitry also can include display driver circuitry, circuitry for driving display drivers, or both. The display circuitry can be operative to display content, e.g., media playback information, application screens for applications implemented on the electronic device 130, information regarding ongoing communications operations, information regarding incoming communications requests, or device operation screens, under the direction of control circuitry 500. Alternatively, the display circuitry can be operative to provide instructions to a remote display.

Communications circuitry 540 can include any suitable communications circuitry operative to connect to a communications network and to transmit communications, e.g., data from electronic device 130 to other devices within the communications network. Communications circuitry 540 can be operative to interface with the communications network using any suitable communications protocol such as, for example, Wi-Fi, e.g., a 802.11 protocol, Bluetooth, radio frequency systems, e.g., 900 MHz, 1.4 GHz, and 5.6 GHz communication systems, infrared, GSM, GSM plus EDGE, CDMA, quadband, and other cellular protocols, VOIP, or any other suitable protocol.

Electronic device 130 can include one more instances of communications circuitry 540 for simultaneously performing several communications operations using different communications networks, although only one is shown in this Figure to avoid overcomplicating the drawing. For example, electronic device 130 can include a first instance of communications circuitry 540 for communicating over a cellular network, and a second instance of communications circuitry 540 for communicating over Wi-Fi or using Bluetooth, in some embodiments, the same instance of communications circuitry 540 can be operative to provide for communications over several communications networks.

In some embodiments, electronic device 130 can be coupled to a host device such as digital content control server 150 for data transfers, synching the communications device, software or firmware updates, providing performance information to a remote source, e.g., providing riding characteristics to a remote server, or performing any other suitable operation that can require electronic device 130 to be coupled to a host device. Several electronic devices 130 can be coupled to a single host device using the host device as a server. Alternatively or additionally, electronic device 130 can be coupled to several host devices, e.g., for each of the plurality of the host devices to serve as a backup for data stored in electronic device 130.

Although the present invention has been described in relation to particular embodiments thereof, many other variations and other uses will be apparent to those skilled in the art. It is preferred, therefore, that the present invention be limited not by the specific disclosure herein, but only by the gist and scope of the disclosure.

What is claimed is:

1. A device for displaying electronic content, the device comprising:
a memory storing the electronic content and storing instructions for operating the device;
a screen;
communications circuitry configured to transmit and receive communications to and from a communications network; and
a control circuitry coupled to the memory, coupled to the screen and coupled to the communications circuitry, the control circuitry executing the instructions and is operable to:
receive comments and linking information from the communications network, the linking information linking the comments to a specific portion of the electronic content; and
display the comments on the screen with the specific portion of the electronic content in accordance with the linking information.

2. The device of claim 1, wherein the specific portion of the electronic content is at least one of a specific sentence of the electronic content, a specific paragraph of the electronic content, and a specific character of the electronic content.

3. The device of claim 2, wherein the communications network includes a server having a discussion module, the control circuitry being operable to receive the comments and linking information from the discussion nodule via the communications circuitry.

4. The device of claim 3, further comprising user interface circuitry coupled to the control circuitry for receiving additional comments regarding the specific portion of the electronic content, wherein the control circuitry is further operable to:
generate additional linking information, the additional linking information linking the additional comments to the specific portion of the electronic content; and
transmit the additional comments and the additional linking information to the discussion module.

5. The device of claim 2, wherein the control circuitry is operable to provide a control icon on the screen, the control icon displaying a discussion panel when activated, the control circuitry displaying the comments via the discussion panel.

6. The device of claim 5, wherein the control circuitry is further operable to display only comments received from an authorized group of users.

7. A server for facilitating discussion about electronic content between first and second devices connected to a communications network, the server comprising:
communications circuitry coupled to the communications network, the communications circuitry being in communication with the first and second devices; and
a discussion module electronically coupled to the communications circuitry, the discussion module being configured to receive from the first device first comments and first linking information linking the first comments to a specific portion of the electronic content, the discussion module being further configured to transmit the first comments and the first linking information to the second device,
the discussion module being further configured to receive from the second device second comments and second linking information linking the second comments to the specific portion of the electronic content, the discussion module being further configured to transmit the second comments and the second linking information to the first device.

8. The server of claim 7, wherein the specific portion of the electronic content is at least one of a specific sentence of the electronic content, a specific paragraph of the electronic content, and a specific character of the electronic content.

9. A method for displaying electronic content, the method comprising:
receiving comments regarding a specific portion of the electronic content from a communications network;
receiving linking information linking the comments to the specific portion of the electronic content from the communications network; and
displaying the comments on a screen of a device with the specific portion of the electronic content in accordance with the linking information.

10. The method of claim 9, wherein the specific portion of the electronic content is at least one of a sentence of the electronic content, a paragraph of the electronic content, and a character of the electronic content.

11. The method of claim 10, wherein the acts of receiving the comments and the linking information include receiving the comments and the linking information from a discussion module of a server connected to the communications network.

12. The method of claim 11, further comprising the acts of:
receiving additional comments regarding the specific portion of the electronic content from user interface circuitry of the device; and
generating additional linking information, the additional linking information linking the additional comments to the specific portion of the electronic content; and
transmitting the additional comments and additional linking information to the discussion module.

13. The method of claim 10, further comprising the act of:
displaying a control icon on the screen, the control icon displaying a discussion panel when activated, the comments being displayed on the screen via the discussion panel.

14. The method of claim 10, wherein the act of displaying the comments on a screen of a device with the specific portion of the electronic content includes displaying only comments received from an authorized group of users.

15. A method of facilitating discussion about electronic content between first and second devices connected to a communications network, the method comprising:
receiving from the first device first comments and first linking information linking the first comments to a specific portion of the electronic content;
transmitting the first comments and the first linking information to the second device,
receiving from the second device second comments and second linking information linking the second comments to the specific portion of the electronic content; and
transmitting the second comments and the second linking information to the first device.

16. The method of claim 15, wherein the transmitting act furthers comprised transmitting the comments and the linking information through a central server.

17. The method of claim 15, wherein the specific portion of the electronic content is at least one of a specific sentence of the electronic content, a specific paragraph of the electronic content, and a specific character of the electronic content.

18. A non-transitory computer-readable media comprising a plurality of instructions that, when executed, cause a device with a screen to:
receive comments regarding a specific portion of electronic content from a communications network;
receive linking information linking the comments to the specific portion of the electronic content from the communications network; display the comments on the screen with the specific portion of the electronic content in accordance with the linking information.

19. The non-transitory computer-readable media of claim 18, wherein the specific portion of the electronic content is at least one of a specific sentence of the electronic content, a specific paragraph of the electronic content, and a specific character of the electronic content.

20. The non-transitory computer-readable media of claim 19, wherein the plurality of instructions cause the device to receive the comments and the linking information from a discussion module of a server connected to the communications network.

21. The non-transitory computer-readable media of claim 20, wherein the plurality of instructions cause the device to:
receive additional comments regarding the specific portion of the electronic content from user interface circuitry of the device; and
transmit the additional comments and additional linking information to the discussion module, the additional linking information linking the additional comments to the specific portion of the electronic content.

22. The non-transitory computer-readable media of claim 19, wherein the plurality of instructions cause the device to:
display a control icon on the screen, the control icon displaying a discussion panel when activated, the comments being displayed on the screen via the discussion panel.

23. The non-transitory computer-readable media of claim 19, wherein the plurality of instructions cause the device to display only the comments received from an authorized group of users.

24. A non-transitory computer-readable media comprising a plurality of instructions that, when executed, cause a server with a discussion module to:
receive from a first device first comments and first linking information linking the first comments to a specific portion of electronic content;
transmit the first comments and the first linking information to a second device,
receive from the second device second comments and second linking information linking the second comments to the specific portion of the electronic content; and
transmit the second comments and the second inking information to the first device.

25. The non-transitory computer-readable media of claim 24, wherein the specific portion of the electronic content is at least one of a specific sentence of the electronic content, a specific paragraph of the electronic content, and a specific character of the electronic content.
